(19) United States
(12) Patent Application Publication
(10) Pub. No.: US 2018/0213462 A1
(43) Pub. Date: Jul. 26, 2018

(54) TRANSMISSION DEVICE, TRANSMISSION CONTROL METHOD, AND RECORDING MEDIUM

(71) Applicant: NEC Corporation, Tokyo (JP)

(72) Inventor: Asami NAKATA, Tokyo (JP)

(73) Assignee: NEC Corporation, Tokyo (JP)

(21) Appl. No.: 15/746,118

(22) PCT Filed: Aug. 2, 2016
(86) PCT No.: PCT/JP2016/003543

§ 371 Date: Jan. 19, 2018

(30) Foreign Application Priority Data
Aug. 3, 2015 (JP) 2015-153537

(51) Int. Cl. H04W 40/12; H04L 12/709

(52) U.S. Cl. CPC H04W 40/12; H04L 45/245

(57) ABSTRACT

The transmission capacities of physical links that constitute link aggregation can be effectively used even when the transmission capacity of any of the physical links varies. A transmission device 100 includes a plurality of virtual ports 120 and a virtual port controller 140. Each of the plurality of virtual ports 120 is assigned to any one of a plurality of wireless ports 110 whose transmission capacity is variable, and provides data transmission with a predetermined transmission capacity using the wireless ports 110 to which the virtual port 120 is assigned. The virtual port controller 140 determines, for each of the plurality of wireless ports 110, a number of virtual ports 120 to be used for data transmission among the virtual ports 120 assigned to the wireless port 110, in accordance with the transmission capacity of the wireless port 110.

### TECHNICAL FIELD

The present invention relates to a transmission device, a transmission control method, and a recording medium.

### BACKGROUND ART

As a technique for interconnecting transmission devices, link aggregation which bundles and treats a plurality of physical links as a single logical link is known. In the link aggregation, an algorithm for equally distributing transmission data to a plurality of physical links that constitute a logical link in order to effectively use the plurality of physical links, is used, as disclosed in PTL 1, for example.

In wireless communication, adaptive modulation is used as a method for selecting an optimum modulation scheme depending on an external environment. When a modulation scheme on a wireless port is changed by adaptive modulation, transmission capacity, which is an available bandwidth, varies, resulting in a difference in transmission capacity between wireless ports. When link aggregation is applied to such wireless communication and the aforementioned algorithm that equally distributes transmission data is used, transmission capacities of the respective wireless ports that constitute a logical port cannot be fully used and transmission data may be discarded.

FIGS. 8 and 9 are diagrams each illustrating an example of link aggregation in typical wireless communication, as described above. In each example in FIGS. 8 and 9, a transmission device 900 includes wireless ports 910 “P1” and “P2” and a link aggregation group (LAG) controller 920. The wireless ports 910 “P1” and “P2” constitute a logical port of a LAG. The wireless ports 910 control selection of a modulation scheme by adaptive modulation. The LAG controller 920 equally distributes transmission data to the wireless ports 910 “P1” and “P2” that constitute the logical port.

For example, when a transmission rate of transmission data is 400 Mbps in FIGS. 8 and 9, the LAG controller 920 distributes the transmission data at 200 Mbps each to the wireless ports 910 “P1” and “P2”.

When the transmission capacities of the wireless ports 910 “P1” and “P2” are same, 300 Mbps, as in FIG. 8, for example, 200 Mbps of transmission data distributed to each of the wireless ports 910 “P1” and “P2” are properly transmitted. On the other hand, when the transmission capacity of the wireless port 910 “P1” changes to 100 Mbps due to adaptive modulation as in FIG. 9, for example, 100 Mbps of transmission data out of 200 Mbps of transmission data distributed to the wireless port 910 “P1” are discarded.

Thus, there is a problem with link aggregation in wireless communication that, when a transmission capacity of a physical link varies, transmission capacities of individual physical links are not effectively used and a transmission rate decreases even if the total of the transmission capacities of the physical links is equal to or greater than the transmission rate of transmission data.

Note that, as related art, PTL 2 discloses a method of determining wireless links to be used by traffic in link aggregation in wireless communication, based on degrees of stability of bands relating to modulation schemes of wireless links and a traffic pattern on a path for each priority level.

### CITATION LIST

### Patent Literature

### [PTL 1] Japanese Patent Application Laid-open Publication No. 2006-5437

[PTL 2] International Patent Publication No. WO 2013/125177

### SUMMARY OF INVENTION

### Technical Problem

As described above, link aggregation as described in PTL 1 has the problem that transmission capacities of individual physical links that constitute the link aggregation cannot be effectively used when the transmission capacity of any of the physical links varies.

An object of the present invention is to solve the problem described above and to provide a transmission device, a transmission control method, and a recording medium that enable transmission capacities of individual physical links that constitute link aggregation to be effectively used even when the transmission capacity of any of the physical links varies.

### Solution to Problem

A transmission device according to an exemplary aspect of the present invention includes: a plurality of virtual ports each of which is assigned to any one of a plurality of physical ports whose transmission capacity is variable, and each of which provides data transmission with a predetermined transmission capacity using the physical port to which the virtual port is assigned; and virtual port control means for determining, for each of the plurality of physical ports, a number of virtual ports to be used for data transmission among the virtual ports assigned to the physical port, in accordance with the transmission capacity of the physical port.

A transmission control method according to an exemplary aspect of the present invention includes: determining, for each of a plurality of physical ports whose transmission capacity is variable, a number of virtual ports to be used for data transmission among virtual ports each of which provides data transmission with a predetermined transmission capacity using the physical port and which are assigned to the physical port, in accordance with the transmission capacity of the physical port.

A computer readable storage medium according to an exemplary aspect of the present invention records thereon a program causing a computer to perform a method including: monitoring a plurality of physical ports whose transmission capacity is variable; and determining, for each of the plurality of physical ports, a number of virtual ports to be used for data transmission among virtual ports each of which provides data transmission with a predetermined transmission capacity using the physical port and which are assigned to the physical port, in accordance with the transmission capacity of the physical port.

### Advantageous Effects of Invention

An advantageous effect of the present invention is that transmission capacities of physical links that constitute link aggregation can be effectively used even when the transmission capacity of any of the physical links varies.

### BRIEF DESCRIPTION OF DRAWINGS

FIG. 1 is a block diagram illustrating a characteristic configuration of an example embodiment of the present invention;

FIG. 2 is a block diagram illustrating a configuration of a transmission device 100 in the example embodiment of the present invention;

FIG. 3 is a block diagram illustrating a configuration of the transmission device 100 implemented by a computer in the example embodiment of the present invention;

FIG. 4 is a flowchart illustrating operation of the transmission device 100 in the example embodiment of the present invention;

FIG. 5 is a diagram illustrating an example of a port count table 151 in the example embodiment of the present invention;

FIG. 6 is a diagram illustrating an example of virtual port information 141 and distribution of transmission data in the example embodiment of the present invention;

FIG. 7 is a diagram illustrating another example of virtual port information 141 and distribution of transmission data in the example embodiment of the present invention;

FIG. 8 is a diagram illustrating an example of link aggregation in typical wireless communication; and

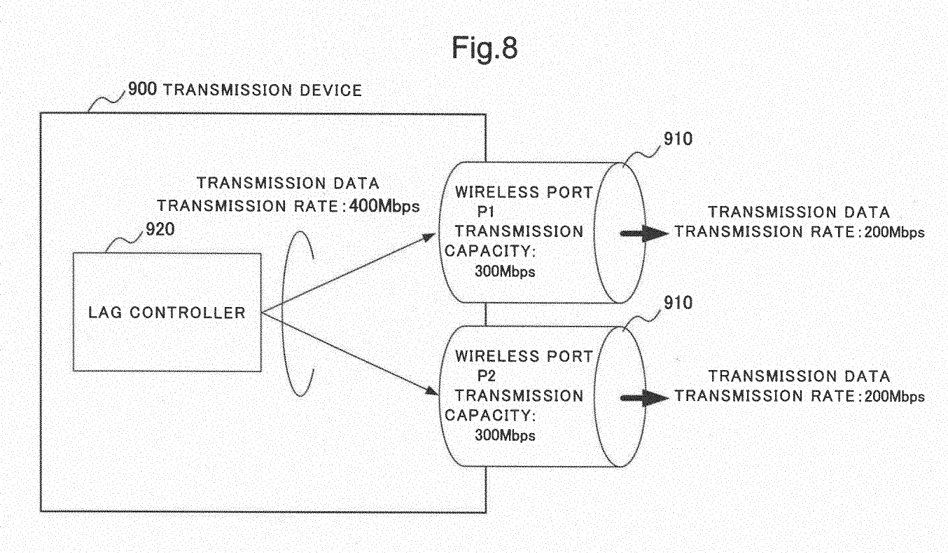

FIG. 9 is a diagram illustrating another example of link aggregation in typical wireless communication.

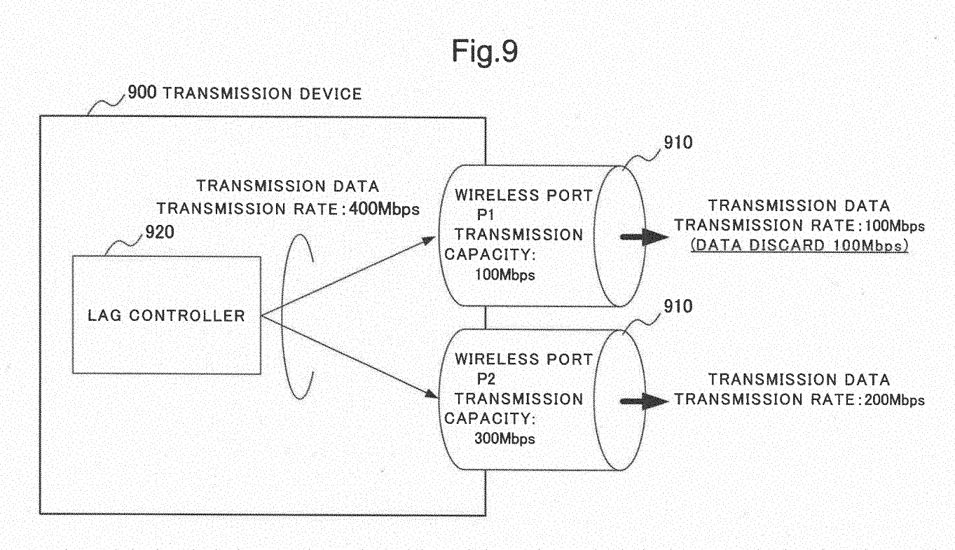

### DESCRIPTION OF EMBODIMENTS

A configuration of an example embodiment of the present invention will be described first. The example embodiment of the present invention will be described by taking as an example a case where a transmission device 100 is a wireless communication device which performs communication (data transmission) with another device via a wireless link. The transmission device 100 may be a microwave communication device or a millimeter-wave communication device which are used on a mobile backhaul, for example.

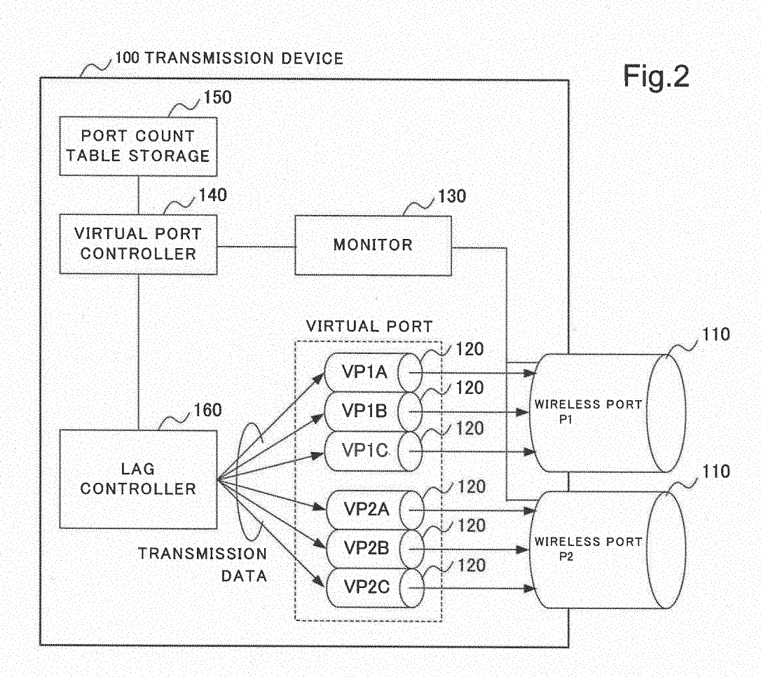

FIG. 2 is a block diagram illustrating a configuration of the transmission device 100 in the example embodiment of the present invention. Referring to FIG. 2, the transmission device 100 includes wireless ports 110 (or physical ports), virtual ports 120, a monitor 130, a virtual port controller 140, a port count table storage 150, and a LAG controller 160 (or a transmission controller). Note that directions of arrows in FIG. 2 are given as examples and are not intended to limit directions of signals between blocks.

The wireless ports 110 provide data transmission to and from other devices via wireless links (or physical links). A plurality of wireless ports 110 constitute a LAG.

In the example in FIG. 2, wireless ports 110 “P1” and 110 “P2” constitute a LAG. Note that a symbol in quotation marks following a reference sign represents an identifier of a component to which the reference sign is given. For example, the wireless port 110 “P1” represents a wireless port 110 that has an identifier “P1”.

Each of the wireless ports 110 controls selection of a modulation scheme by using adaptive modulation in accordance with a state of the wireless link. Modulation schemes include quadrature phase shift keying (QPSK), 16 quadrature amplitude modulation (QAM), 64 QAM, and the like. The transmission capacity of each wireless port 110 depends on the modulation scheme. For example, in the case where the transmission capacity via QPSK is 100 Mbps, the transmission capacity via 16 QAM is 200 Mbps and the transmission capacity via 64 QAM is 300 Mbps.

The virtual ports 120 are virtual ports for providing data transmission via the wireless ports 110. Each of the virtual ports 120 provides data transmission with a predetermined (equal) transmission capacity. Each of the virtual ports 120 is assigned to any one of the wireless ports 110 in advance.

In the example in FIG. 2, virtual ports 120 “VP1A” to “VP1C” are assigned to the wireless port 110 “P1” and virtual ports 120 “VP2A” to “VP2C” are assigned to the wireless port 110 “P2”.

The monitor 130 monitors states of the wireless ports 110. When the monitor 130 detects a change of a modulation scheme at any of the wireless ports 110, the monitor 130 notifies the virtual port controller 140 of a modulation scheme after the change.

The port count table storage 150 stores a port count table 151. The port count table 151 indicates, for each modulation scheme, the number of virtual ports 120 to be used in data transmission. As the number of the virtual ports 120, for example, the largest possible number of virtual ports 120 is set under the condition where the total value of the predetermined transmission capacities of the number of the virtual ports 120 is equal to or less than a transmission capacity that depends on the modulation scheme.

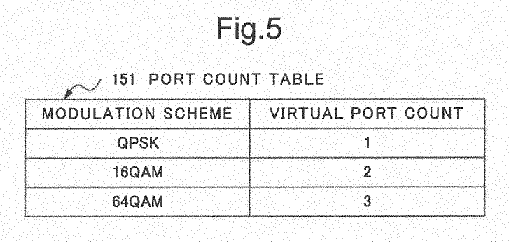

FIG. 5 is a diagram illustrating an example of the port count table 151 in the example embodiment of the present invention. In the example in FIG. 5, the numbers of virtual ports 120, “1”, “2” and “3”, are set for modulation schemes “QPSK”, “16 QAM”, and “64 QAM”, respectively.

The virtual port controller 140 determines, in accordance with the transmission capacity of each wireless port 110, the number of virtual ports 120 to be used for data transmission among virtual ports 120 assigned to the wireless port 110. The virtual port controller 140 determines the number of virtual ports 120 in accordance with the transmission capacity that is determined depending on a modulation scheme, by acquiring the number of virtual ports 120 associated with the modulation scheme of the wireless port 110. The virtual port controller 140 then selects the determined number of virtual ports 120 as virtual ports 120 to be used in the data transmission from among the virtual ports 120 assigned to the wireless port 110. The virtual port controller 140 generates virtual port information 141 indicating availability of each virtual port 120 and sends the virtual port information 141 to the LAG controller 160.

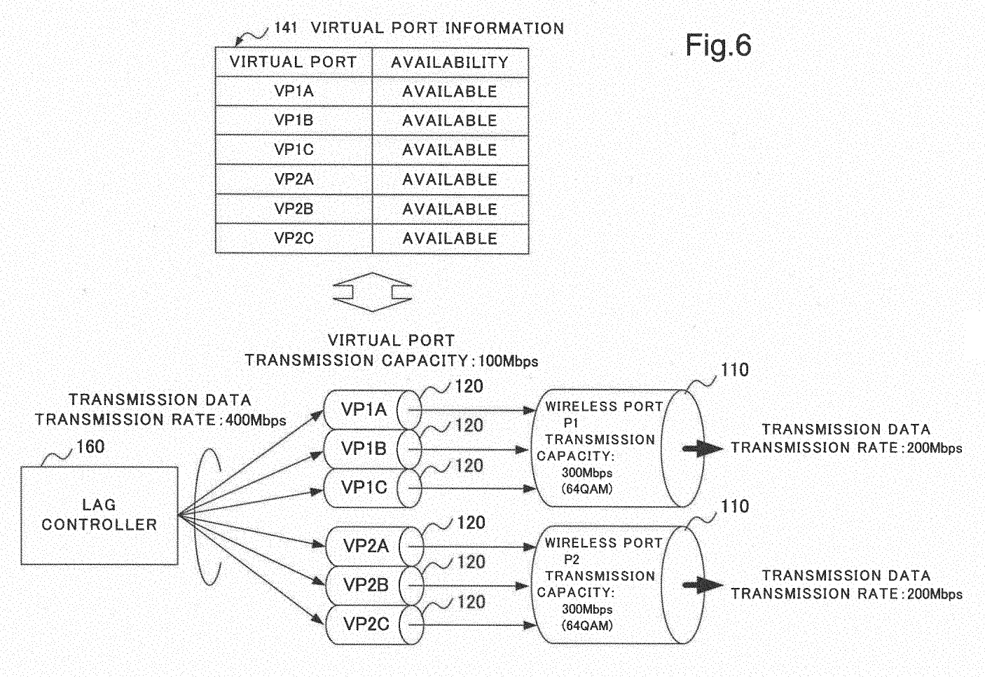

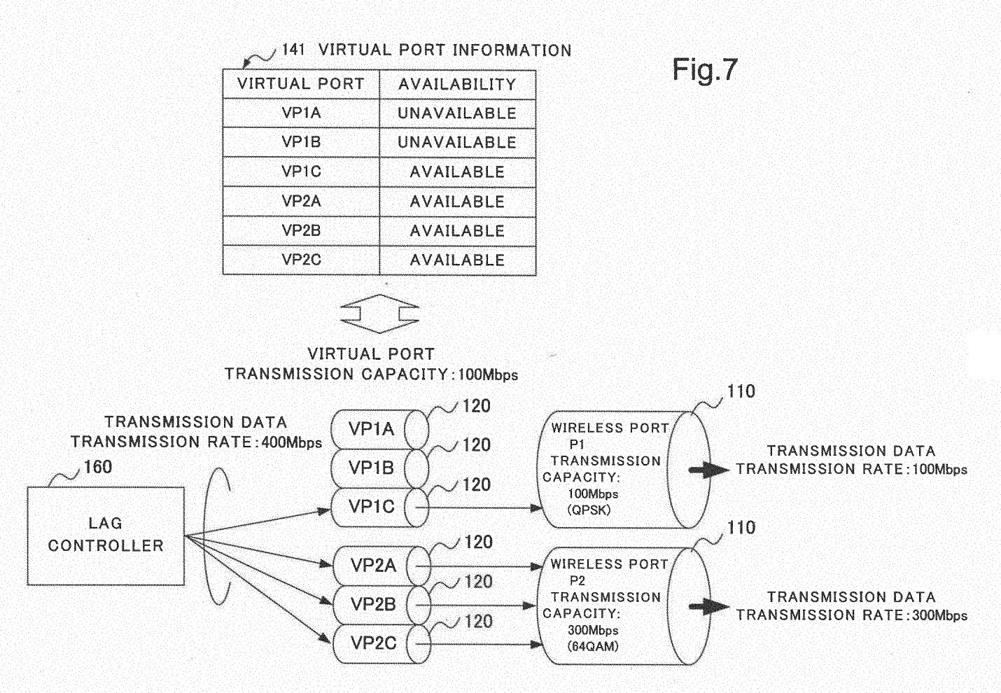

FIGS. 6 and 7 are diagrams illustrating examples of virtual port information 141 and distribution of transmission data in the example embodiment of the present invention. In the virtual port information 141, availability of each of the virtual ports 120 is indicated in association with an identifier of the virtual port 120, by “available”, which represents that the virtual port 120 is used or “unavailable”, which represents that the virtual port 120 is not used.

Note that, as long as the number of virtual ports 120 is determined in accordance with the transmission capacity of each wireless port 110, the virtual port controller 140 may determine the number of virtual ports 120 by using a method other than the method of acquiring the number that is associated with the modulation scheme. For example, the virtual port controller 140 may calculate the number of virtual ports 120 by dividing a value of the transmission capacity acquired from the wireless port 110 by a value of the predetermined transmission capacity of the virtual port 120.

The LAG controller 160 transmits transmission data through virtual ports 120. The LAG controller 160 treat the logical port of the LAG as composed of virtual ports 120 whose availability is “available” in the virtual port information 141. The LAG controller 160 sends transmission data by distributing the transmission data to the virtual ports 120 whose availability is “available” in such a way that transmission rates of the virtual ports 120 are equal to each other. The LAG controller 160 may send the transmission data by distributing the transmission data in such a way that the transmission rates are substantially equal.

Note that the transmission device 100 may be implemented by using a computer that includes a central processing unit (CPU) and a storage medium storing a program and operates under control based on the program.

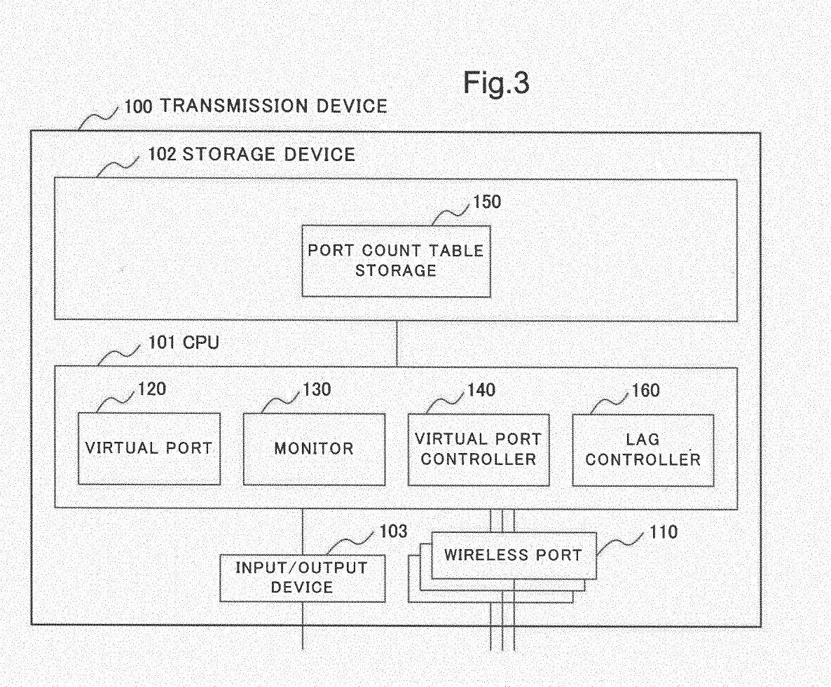

FIG. 3 is a block diagram illustrating a configuration of the transmission device 100 that is implemented by a computer in the example embodiment of the present invention.

The transmission device 100 in this case includes a CPU 101, a storage device 102 (a storage medium) such as a hard disk and/or a memory, input/output devices 103 such as a keyboard and a display, and wireless ports 110. The CPU 101 executes a computer program for implementing virtual ports 120, a monitor 130, a virtual port controller 140 and a LAG controller 160. The storage device 102 stores data (a port count table 151) in a port count table storage 150. The input/output devices 103 provide inputs and outputs of various settings and the like relating to the transmission device 100 from and to a user or the like.

Components of the transmission device 100 may be independent logic circuits.

Next, the operation in the example embodiment of the present invention will be described.

It is assumed here that a transmission rate of each virtual port 120 is 100 Mbps and a transmission rate of transmission data is 400 Mbps, in the transmission device 100 of FIG. 2. It is also assumed that the port count table 151 in FIG. 5 is stored in the port count table storage 150.

It is further assumed that the wireless ports 110 “P1” and “P2” have a transmission capacity of 300 Mbps (modulation scheme “64 QAM”), and the availability of the virtual ports 120 “VP1A” to “VP1C” and “VP2A” to “VP2C” in virtual port information 141 are “available”, as illustrated in FIG. 6. In this case, the LAG controller 160 sends 400 Mbps of transmission data by equally distributing the transmission data to the six virtual ports 120 “VP1A” to “VP1C” and “VP2A” to “VP2C” in accordance with the virtual port information 141, as illustrated in FIG. 6. Consequently, 200 Mbps of transmission data are transmitted through each of the wireless ports 110 “P1” and “P2”.

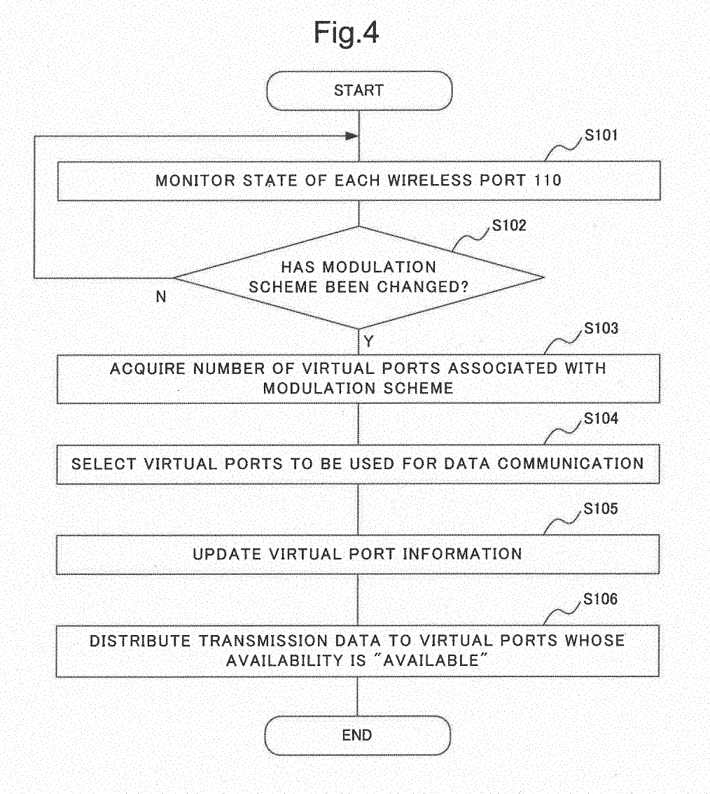

FIG. 4 is a flowchart illustrating the operation of the transmission device 100 in the example embodiment of the present invention.

First, the monitor 130 monitors states of the wireless ports 110 (step S101).

When a modulation scheme at a wireless port 110 is changed (step S102: Y), the monitor 130 notifies the virtual port controller 140 of the identifier of the wireless port 110 whose modulation scheme has been changed and a modulation scheme after the change.

For example, when the modulation scheme at the wireless port 110 “P1” is changed from “64 QAM” to “QPSK” as illustrated in FIG. 7, the monitor 130 notifies the virtual port controller 140 of the identifier “P1” of the wireless port 110 and the modulation scheme “QPSK”.

The virtual port controller 140 acquires the number of virtual ports 120 associated with the modulation scheme notified by the monitor 130 from the port count table 151 (step S103). The virtual port controller 140 then selects the determined number of virtual ports 120 as virtual ports 120 to be used for data transmission from among the virtual ports 120 assigned to the wireless port 110 (step S104). The virtual port controller 140 updates the virtual port information 141 in accordance with the result of the selection (step S105) and sends the updated virtual port information 141 to the LAG controller 160.

For example, the virtual port controller 140 acquires the number of the virtual ports 120, “1”, associated with the modulation scheme “QPSK” from the port count table 151 in FIG. 5. The virtual port controller 140 selects the virtual port 120 “VP1C”, for example, from among the virtual ports 120 “VP1A” to “VP1C” assigned to the wireless port 110 “P1”. As illustrated in FIG. 7, the virtual port controller 140 sets “unavailable” as the availability of the virtual ports 120 “VP1A” and “VP1B” and sets “available” as the availability of the virtual port 120 “VP1C” in the virtual port information 141. Then, the virtual port controller 140 sends the virtual port information 141 to the LAG controller 160.

The LAG controller 160 sends transmission data by distributing the transmission data to the virtual ports 120 whose availability is “available” in accordance with the virtual port information 141 in such a way that the transmission rates of the virtual ports 120 are equal to each other (step S106).

For example, the LAG controller 160 sends 400 Mbps of transmission data by equally distributing the transmission data to four virtual ports 120 “VP1C” and“VP2A” to “VP2C” in accordance with the virtual port information 141 as illustrated in FIG. 7. This enables to transmit the transmission data at a transmission rate of 100 Mbps through the wireless port 110 “P1” and at a transmission rate of 300 Mbps through the wireless port 110 “P2” without discarding.

With this, the operation in the example embodiment of the present invention ends.

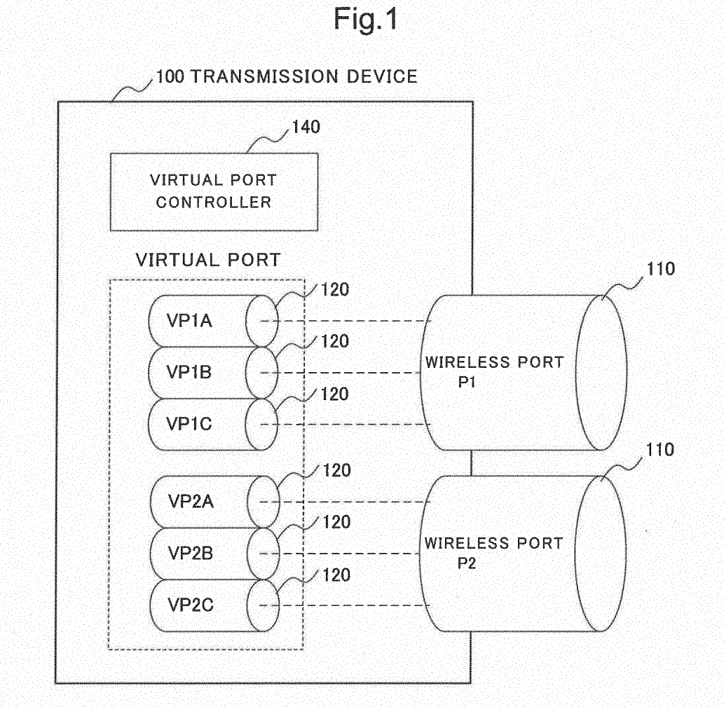

Next, a characteristic configuration of the example embodiment of the present invention will be described. FIG. 1 is a block diagram illustrating a characteristic configuration of the example embodiment of the present invention.

Referring to FIG. 1, a transmission device 100 includes a plurality of virtual ports 120 and a virtual port controller 140. Each of the plurality of virtual ports 120 is assigned to any one of a plurality of wireless ports 110 (physical ports) whose transmission capacity is variable, and provides data transmission with a predetermined transmission capacity using the wireless ports 110 to which the virtual port 120 is assigned. The virtual port controller 140 determines, for each of the plurality of wireless ports 110, a number of virtual ports 120 to be used for data transmission among the virtual ports 120 assigned to the wireless port 110, in accordance with the transmission capacity of the wireless port 110.

Next, advantageous effects of the example embodiment of the present invention will be described.

According to the example embodiment of the present invention, the transmission capacities of the individual physical lines that constitute a link aggregation can be effectively used even when the transmission capacity of any of the physical links varies. This is because the virtual port controller 140 of the transmission device 100 determines, in accordance with the transmission capacities of the individual wireless ports 110, the number of virtual ports 120 to be used for data transmission among virtual ports 120 that provide data transmission with a predetermined transmission capacity using the wireless port 110. This enables to send transmission data by distributing the transmission data to the determined number of virtual ports 120 in such a way that the transmission rates are equal to each other, and transmit the transmission data from each wireless port 110 at a transmission rate in accordance with the transmission capacity of the wireless port 110. Thus, when the total of the transmission capacities of the wireless ports 110 is equal to or greater than the transmission rate of the transmission data, the transmission capacities of the individual physical links that constitute the link aggregation are effectively used and the transmission rate does not decrease (discarding of transmission data does not occur).

Further, according to the example embodiment of the present invention, such effective use of transmission capacities of physical links that constitute a link aggregation can be easily achieved by using a typical LAG controller 160 which performs distribution of transmission data. This is because the virtual port controller 140 selects the determined number of virtual ports in accordance with the transmission capacities of the individual wireless ports 110, and notifies the LAG controller 160 of the selected virtual ports 120. When the LAG controller 160 simply distributes the transmission data to the selected virtual ports 120 instead of the wireless ports 110 that constitute the LAG, the transmission capacities of individual physical links are used effectively.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims. A system or a device that is made by combining, in any manner, respective characteristics included in the example embodiments is included in scope of the present invention.

For example, while the example embodiment of the present invention has been described by taking an example in which physical links are wireless links. However, wired links or a mixture of wired and wireless links may be used as physical links as long as transmission capacities of the links are variable.

This application is based upon and claims the benefit of priority from Japanese patent application No. 2015-153537, filed on Aug. 3, 2015, the disclosure of which is incorporated herein in its entirety by reference.

### REFERENCE SIGNS LIST

100 Transmission device
101 CPU
102 Storage device
103 Input/output device
110 Wireless port
120 Virtual port
130 Monitor
140 Virtual port controller
141 Virtual port information
150 Port count table storage
151 Port count table
160 LAG controller
900 Transmission device
910 Wireless port
920 LAG controller

1. A transmission device comprising:
a plurality of virtual ports each of which is assigned to any one of a plurality of physical ports whose transmission capacity is variable, and each of which provides data transmission with a predetermined transmission capacity using the physical port to which the virtual port is assigned; and
a virtual port controller that determines, for each of the plurality of physical ports, a number of virtual ports to be used for data transmission among the virtual ports assigned to the physical port, in accordance with the transmission capacity of the physical port.

2. The transmission device according to claim 1, wherein
the virtual port controller selects the determined number of virtual ports among virtual ports assigned to each of the plurality of physical ports, as virtual ports to be used for data transmission; and
the transmission device further comprises a transmission controller that sends transmission data by distributing the transmission data to the selected virtual ports in such a way that transmission rates are substantially equal to each other.

3. The transmission device according to claim 1, wherein
the virtual port controller determines, for each of the plurality of physical ports, the number of virtual ports to be used for data transmission in such a way that a total value of the predetermined transmission capacities of the number of virtual ports used for the data transmission is equal to or less than the transmission capacity of the physical port.

4. The transmission device according to claim 1, wherein
the virtual port controller determines the number of virtual ports to be used for the data transmission, depending on a modulation scheme of each of the plurality of physical ports.

5. A transmission control method comprising:
determining, for each of a plurality of physical ports whose transmission capacity is variable, a number of virtual ports to be used for data transmission among virtual ports each of which provides data transmission with a predetermined transmission capacity using the physical port and which are assigned to the physical port, in accordance with the transmission capacity of the physical port.

6. The transmission control method according to claim 5, further comprising:
selecting the determined number of virtual ports among the virtual ports assigned to each of the plurality of physical ports, as virtual ports to be used for data transmission; and
sending transmission data by distributing the transmission data to the selected virtual ports in such a way that transmission rates are substantially equal to each other.

7. The transmission control method according to claim 5, wherein,
for each of the plurality of physical ports, the number of virtual ports to be used for data transmission is determined in such a way that a total value of the predetermined transmission capacities of the number of virtual ports used for the data transmission is equal to or less than the transmission capacity of the physical port.

8. The transmission control method according to claim 5, wherein
the number of virtual ports to be used for the data transmission is determined, depending on a modulation scheme of each of the plurality of physical ports.

9. A non-transitory computer readable storage medium recording thereon a program causing a computer to perform a method comprising:
monitoring a plurality of physical ports whose transmission capacity is variable; and
determining, for each of the plurality of physical ports, a number of virtual ports to be used for data transmission among virtual ports each of which provides data transmission with a predetermined transmission capacity using the physical port and which are assigned to the physical port, in accordance with the transmission capacity of the physical port.

10. The non-transitory computer readable storage medium recording thereon the program according to claim 9 causing the computer to perform the method, further comprising:
selecting the determined number of virtual ports among the virtual ports assigned to each of the plurality of physical ports, as virtual ports to be used for data transmission; and
sending transmission data by distributing the transmission data to the selected virtual ports in such a way that transmission rates are substantially equal to each other.
